(19) United States
(12) Patent Application Publication
(10) Pub. No.: US 2005/0102494 A1
(43) Pub. Date: May 12, 2005

(54) Method and apparatus for register stack implementation using micro-operations

(76) Inventors: Edward T. Grochowski, San Jose, CA (US); Jeffrey P. Rupley II, Round Rock, TX (US); Partha P. Kundu, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/712,618

(22) Filed: Nov. 12, 2003

(51) Int. Cl. G06F 9/00

(52) U.S. Cl. 712/228

(57) ABSTRACT

Disclosed are embodiments of an apparatus, system, and method for implementing a register stack using micro-operations. A register stack engine generates a plurality of micro-operations to implement a memory operation in support of register windowing, such as spill or fill to/from a backing store. These micro-operations are inserted into an execution pipeline along with other micro-operations not related to register stack operation.

### BACKGROUND

1. Technical Field

The present disclosure relates generally to information processing systems and, more specifically, to processors that maintain a register stack.

2. Background Art

Some processor architectures, namely the Explicitly Parallel Instruction Computing (“EPIC”) architecture utilized by Itanium® and Itanium® 2 microprocessors, feature a register stack to provide fresh registers, called a register frame (also referred to as a “window”), when a procedure is called. The purpose of such register stack is to transfer data between a finite-sized physical register stack and memory in order to create the appearance of an infinitely large virtual register stack.

A hardware structure, referred to as a register stack engine (“RSE”), helps to maintain the register stack by causing the processor to save and restore the contents of physical registers to memory when needed. The RSE injects spill (store) operations into an execution pipeline in order to save old register values to memory if the register stack does not have enough free space to accommodate registers needed for a new procedure call. Similarly, the RSE injects fill (load) operations into an execution pipeline in order to retrieve spilled register values from memory when they are needed as a result of a procedure return.

Traditionally, spill and fill operations are executed by a processor via hardwired spill or fill instructions. For an out-of-order processor, however, it would be desirable for spill and fill operations to accommodate structures that support out-of-order execution, such as out-of-order rename units and out-of-order schedulers, and to enable the out-of-order schedulers to overlap the execution of spill and fill operations with the execution of other instructions.

### BRIEF DESCRIPTION OF THE DRAWINGS

The present invention may be understood with reference to the following drawings in which like elements are indicated by like numbers. These drawings are not intended to be limiting but are instead provided to illustrate selected embodiments of a method, apparatus and system for implementing a register stack using micro-operations (“micro-ops”).

FIG. 1 is a block diagram of at least one embodiment of a processing system capable of utilizing disclosed techniques.

FIG. 2 is a block diagram illustrating selected micro-architectural features of at least one embodiment of a processor.

FIGS. 3 is a flow diagram illustrating at least one embodiment of a generalized execution pipeline for an out-of-order processor.

FIG. 4 is a block diagram illustrating at least one embodiment of a format for spill and fill micro-ops generated by at least one embodiment of a register stack engine.

FIG. 5 is a flowchart illustrating at least one embodiment of a method for generating one or more micro-ops for a parallel spill operation.

FIG. 6 is a flowchart illustrating at least one embodiment of a method for generating one or more micro-ops for a parallel fill operation.

FIG. 7 is a flowchart illustrating at least one embodiment of a method for generating one or more micro-ops for a merged spill operation on a single memory port.

FIG. 8 is a flowchart illustrating at least one embodiment of a method for generating one or more micro-ops for a merged fill operation on a single memory port.

FIG. 9 is a block diagram of at least one embodiment of an illustrative backing store.

FIG. 10 is a block data flow diagram illustrating an example series of spill operations implemented with micro-ops.

FIG. 11 is a block data flow diagram illustrating an example series of fill operations implemented with micro-ops.

### DETAILED DESCRIPTION

Described herein are selected embodiments of a system, apparatus and methods for implementing a register stack using micro-operations. In the following description, numerous specific details such as processor types, pipeline stages, instruction formats and syntax, renaming mechanisms, and control flow ordering have been set forth to provide a more thorough understanding of the present invention. It will be appreciated, however, by one skilled in the art that the invention may be practiced without such specific details. Additionally, some well-known structures, circuits, and the like have not been shown in detail to avoid unnecessarily obscuring the present invention.

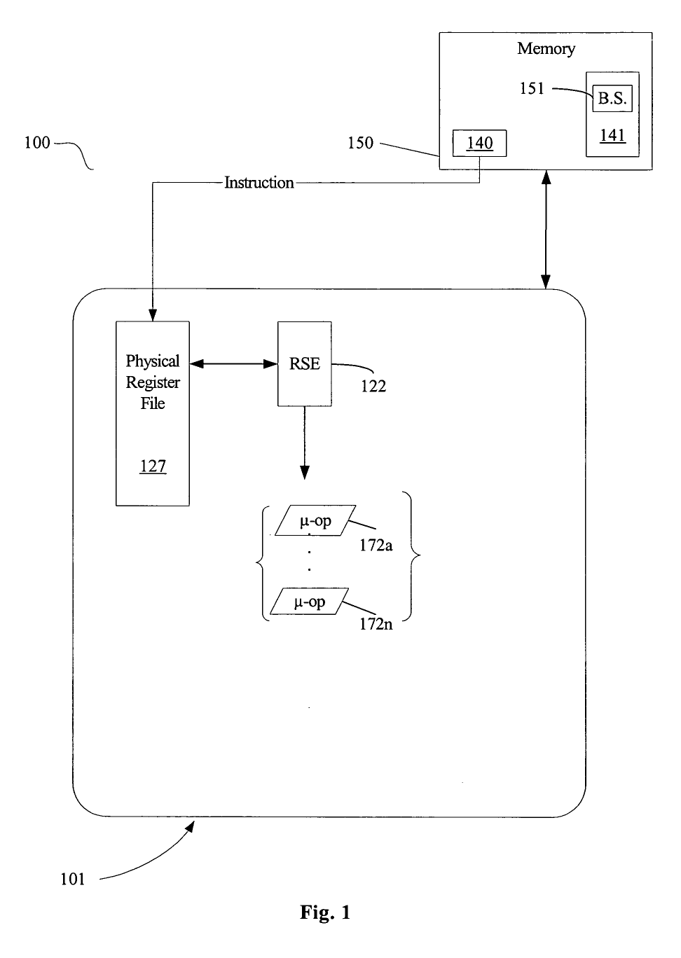

FIG. 1 is a block diagram illustrating at least one embodiment of a processing system 100 capable of implementing a register stack with micro-operations rather than with hardwired spill and fill operations. FIG. 1 illustrates that processing system 100 includes a memory 150 in which instructions may be stored. Instructions stored in the instruction space 140 of memory 150 may be forwarded to a processor 101 during operation. Although not depicted in FIG. 1, one of skill in the art will recognize that the instruction may be fetched, decoded, and/or stored in a cache (not shown).

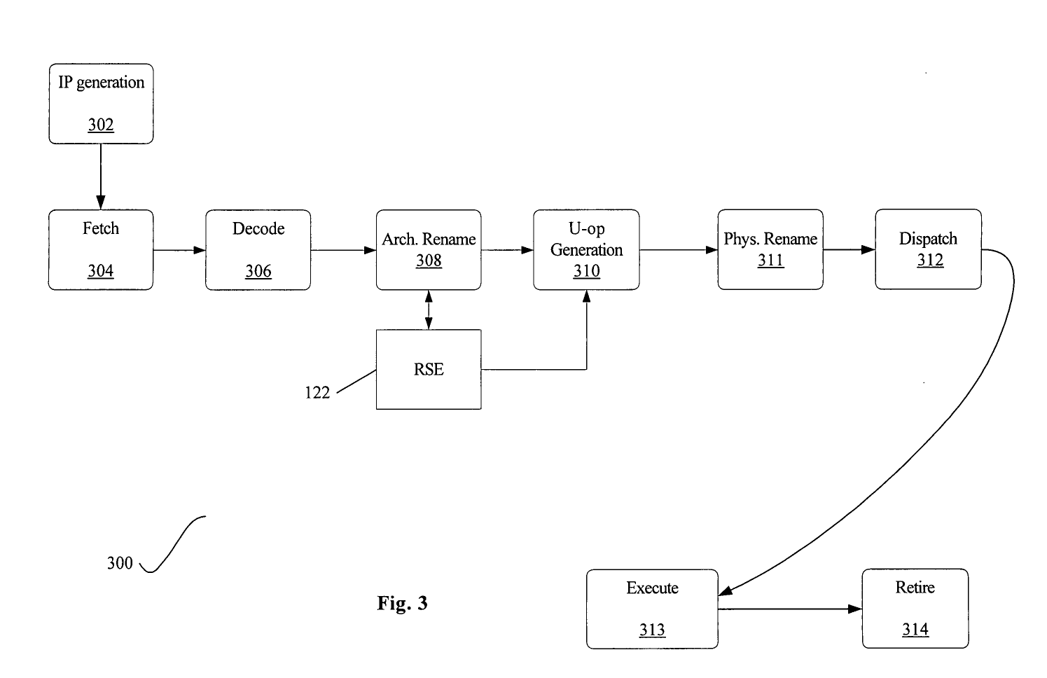

The processing system 100 thus also includes a processor 101 to perform out-of-order execution of the instructions. The processor 101 may utilize an execution pipeline 300 (see FIG. 3), which includes multiple dynamic pipeline stages.

FIG. 1 illustrates that the processor 101 may include a register stack engine (RSE) 122. The RSE 122 generates micro-operations 172a-172n, sometimes referred to herein as “micro-ops” or “μ-ops”, to effect saving and restoring the contents of physical registers in a physical register file 127 to memory 150 when needed. That is, the RSE 122 operates to provide the illusion of an infinitely large virtual register stack.

The RSE 122 may generate micro-ops for a register window operation, such as a fill or spill. Such register window operations may sometimes be referred to herein as “RSE operations.”

For such embodiment, a portion of the registers in the physical register file 127 in the processor 101 is utilized to implement a register stack to provide fresh registers, the fresh registers being referred to a register frame (also referred to as a “window”), when a procedure is called with an allocation instruction. For at least one embodiment, the first 32 registers of a 128-register register file 127 are static, and the remaining 96 registers implement a register stack to provide fresh registers when an allocation instruction is executed (which typically occurs after a call instruction). One commonly-recognized benefit of register windowing is reduced call/return overhead associated with saving and restoring register values that are defined before a subroutine call, and used after the subroutine call returns.

The RSE 122 injects spill and fill micro-ops 172a-172n into the execution pipeline (see 300, FIG. 3) as needed to deal with overflow and underflow conditions during register windowing. In this manner, the RSE 122 triggers memory operations in support of register windowing.

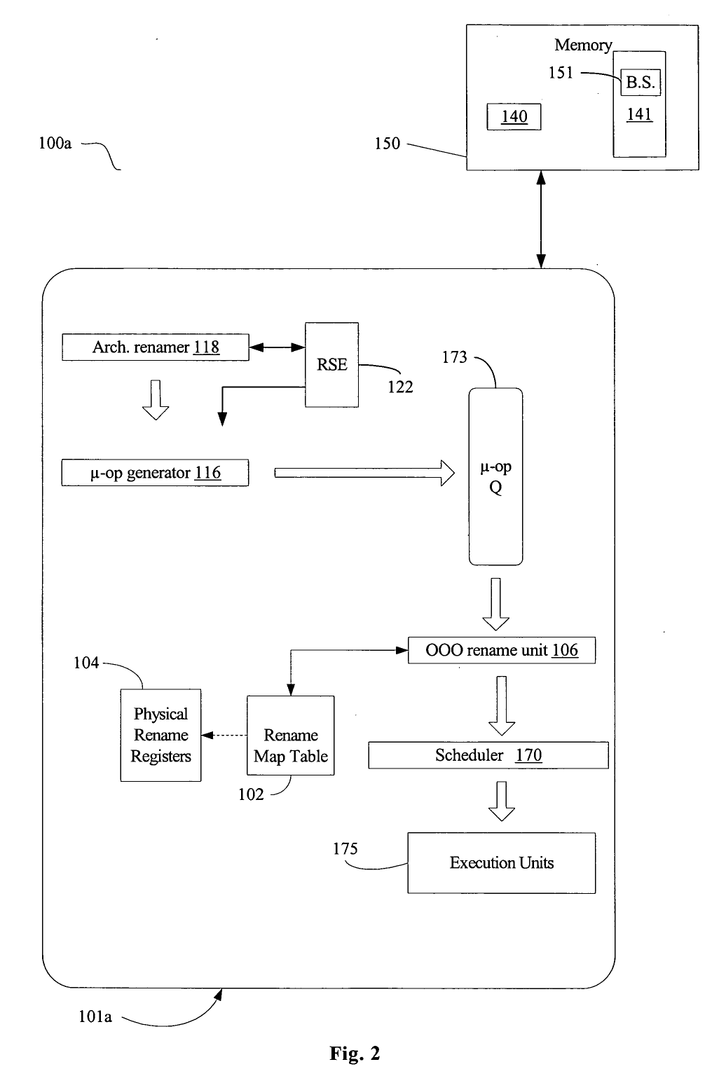

FIG. 2 illustrates that the micro-ops may be stored in a micro-op queue 173 before being scheduled into the pipeline. Inserting micro-ops into the micro-op queue 173 may be considered a first step for inserting the micro-ops into the execution pipeline. However, for at least one other embodiment, no micro-op queue 173 is present and the micro-ops are therefore scheduled into the pipeline without utilizing a micro-op queue 173.

For at least one embodiment, the RSE 122 injects spill and fill micro-ops 172a-172n into an execution pipeline according to the following guidelines:
a. When a procedure allocates a new stack frame, if the top of the frame (active region) extends beyond the top of the physical register stack window, then the window is moved up by spilling some dirty registers to a backing store 151 in memory 150. These dirty registers belong to the current procedure's callers.
b. After a procedure returns and its stack frame is discarded, if the bottom of the caller's frame (now the active region) extends beyond the bottom of the physical register stack window, then the window is moved down by filling registers from the backing store 151. These registers belong to the current procedure.
c. Spills/fills are not generated for procedure calls, allocation instructions, and returns within the physical register stack window.

FIG. 2 illustrates selected micro-architectural details for at least one embodiment of a processor 101a included in a processing system 100a. FIG. 2 illustrates that an embodiment 101a of a processor may include an architectural renamer 118 to provide renaming that supports register windowing and register rotation. To simplify keeping track of architectural (“logical”) registers versus physical registers, the architectural renamer 118 renames logical registers (as used by overlapping procedure frames) onto physical registers. For at least one embodiment, such renaming is performed such that the portion of the general register file that supports renaming is addressed starting at a predetermined general register number. For at least one embodiment, for example, renaming is performed such the first input register for a procedure is named to start at a predetermined register number, such as 32 (“Gr32”), which is the first non-static register.

The architectural renamer 118 may perform such renaming during an architectural rename stage of a pipeline (see stage 308 of pipeline 300 in FIG. 3). The architectural rename stage (308, FIG. 3) may occur after a decode stage (see, e.g., 306, FIG. 3) and before a micro-op conversion stage (see, e.g., 310, FIG. 3).

Accordingly, although the register frame of any called function may start from any one of the physical registers Gr32-Gr128, responsive to allocation, call, or return instructions, the architectural renamer 118 renames the current starting physical register to Gr32. The naming of subsequent physical registers of the function's register frame continues, renaming the next physical registers to Gr33, Gr34 and so on.

A procedure's register frame includes local and output registers. On a procedure call, the architectural renamer 118 hides the current stack frame's local registers and the output registers become part of the new procedure's local registers. In addition to the benefits of register windowing mentioned above, the architectural register renamer 118 enables a register operation known as “register rotation”, which is used in specialized optimizing constructs known as software pipelining to increase the amount of parallelism within a loop.

FIG. 2 illustrates that processor 101a may also include physical rename registers 104 and a rename map table 102. The processor 101a may also include an out-of-order (“000”) register rename unit 106. The 000 rename unit 106, map table 102 and physical rename registers 104 are all utilized for the purpose of 000 register renaming.

Out-of-order rename unit 106 performs renaming by mapping an architectural register to a physical rename register 104 in order to dynamically increase instruction-level parallelism in the instruction stream. That is, for each occurrence of an architectural register in an instruction in the instruction stream of the processor 101 a, out-of-order rename unit 106 may map such occurrence to a physical register in such a manner as to minimize WAR (write-after-read) and WAW (write-after-write) data dependencies in the instruction stream.

As used herein, the term “instruction” is intended to encompass any type of instruction that can be understood and executed by functional units 175, including macro-instructions and micro-operations. Accordingly, micro-operations are instructions of a format that may be understood and executed by functional units 175. In contrast, as used herein, the term “instruction word” may be utilized to denote a VLIW instruction that is too large to be understood and executed by a single execution unit.

For instance, the RSE 122 may generate, directly or indirectly, a load micro-op responsive to receipt of an instruction word that includes a “call” instruction, if a spill micro-op is warranted for the call instruction. Similarly, the RSE 122 may generate, directly or indirectly, a store micro-op responsive to receipt of an instruction word that includes a “ret” instruction, if a fill micro-op is warranted for the ret instruction.

During out-of-order renaming for architectural registers, at least one embodiment of the out-of-order rename unit 106 enters data into the map table 102. The map table 102 is a storage structure to hold one or more rename entries. In practice, the actual entries of the map table 102 form a translation table that keeps track of mapping of architectural registers, which are defined in the instruction set, to physical rename registers 104. The physical rename registers 104 may maintain intermediate and architected data state for the architectural register being renamed. One of skill in the art will recognize that renaming may be performed concurrently for multiple threads.

Accordingly, it has been described that the map table 102 and physical registers 104 facilitate out-of-order renaming, by OOO rename unit 106, of architectural registers defined in an instruction set. The renaming may occur during a physical rename pipeline stage 311 (see FIG. 3).

Accordingly, the processor 101a illustrated in FIG. 2 may include both an architectural renamer 118 and an OOO rename unit 106. For at least one embodiment, such processor 101a may thus perform a two-stage rename process that includes both architectural renaming and out-of-order renaming. Such two-stage rename process is discussed in further detail below.

Reference to FIG. 3 illustrates an embodiment of the execution pipeline 300 mentioned above. The illustrative pipeline 300 illustrated in FIG. 3 includes the following stages: instruction pointer generation 302, instruction fetch 304, instruction decode 306, architectural register rename 308, μ-op generation 310, physical register rename 311, dispatch 312, execution 313, and instruction retirement 314. The pipeline 300 illustrated in FIG. 3 is illustrative only; the techniques described herein may be used on any processor. For an embodiment in which the processor utilizes an execution pipeline 300, the stages of a pipeline 300 may appear in different order than that depicted in FIG. 3.

FIG. 3 illustrates the two-stage renaming scheme discussed above. FIG. 3 illustrates that a RSE 122 generates spill and fill micro-ops to support register windows and inserts such micro-ops into the architectural rename phase 308 of an execution pipeline 300. Accordingly, the spill and fill micro-ops are thus subject to the same architectural renaming (see stage 308) and out-of-order renaming (see stage 311), as well as scheduling (see stage 312) and execution (see stage 313) as “other” micro-ops generated during a micro-op generation stage (see stage 310).

The techniques disclosed herein may be utilized on a processor whose pipeline 300 may include different or additional pipeline stages to those illustrated in FIG. 3. For example, alternative embodiments of the pipeline 300 may include additional pipeline stages for rotation, expansion, exception detection, etc. In addition, a VLIW-type (very long instruction word) processor may include different pipeline stages, such as a word-line decode stage, than appear in the pipeline for a processor that includes variable-length instructions in its instruction set.

FIGS. 2 and 3 thus illustrate that register renaming for an instruction may be performed as a two-stage process. Architectural renaming may be performed by an architectural renamer 118 during an architectural rename pipeline stage 308 of a pipeline 300. An OOO rename unit 106, during an out-of-order rename stage 311 of the pipeline 300, may also perform out-of-order renaming.

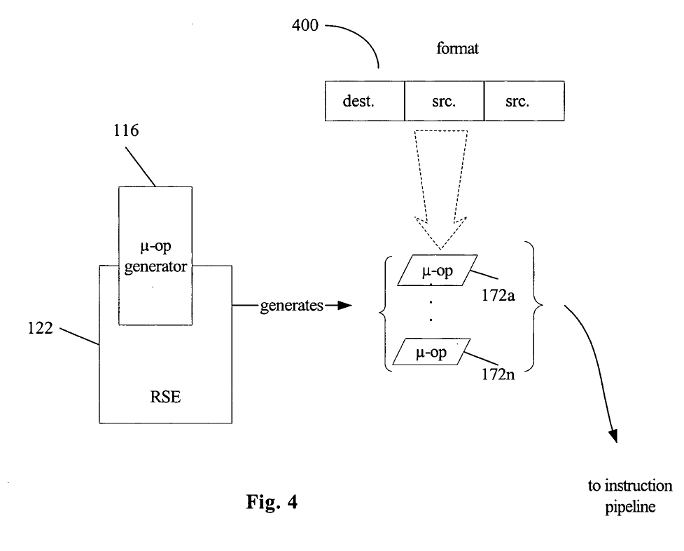

Turning to FIG. 4, further discussion of the operation of the RSE 122 follows. The RSE 122 generates, either directly or indirectly, one or more micro-ops 172 to effect a spill operation when the register stack does not have enough free registers to accommodate a procedure or function call. Similarly, the RSE 122 generates one or more micro-ops to 172 effect a fill operation to restore saved register values from memory to accommodate a return instruction.

In each case, the micro-ops have a fixed format 400 illustrated in FIG. 4. FIG. 4 illustrates that at least one embodiment of the format for each micro-op generated by the RSE 122 for spills and fills includes two source operands and one destination operand. For at least one embodiment, micro-ops following the fixed format 400 are easier for an out-of-order processor (such as, for instance, processors 101 and 101a illustrated in FIGS. 1 and 2, respectively) to rename, schedule and execute than variable-format micro-ops would be.

During micro-op generation for spills and fills, at least one embodiment of the RSE 122 makes implicit operands for spill and fill operations explicit. That is, register window operations, such as spills and fills, may be associated with operations on implicit operands. For example, at least one embodiment of processors 101 and 101a (FIGS. 1 and 2, respectively) provide special-purpose application registers such as a backing store pointer register (BSPSTORE) for memory stores, a backing store load pointer register (BSPLOAD), and a Not-a-thing bit (NaT) collection register (RNAT) in order for the RSE to maintain status information, such as deferred exception information. Processing for such special-purpose application registers may be implicitly handled during a traditional spill or fill operation. However, the RSE 122 may generate one or more micro-operations for a register window operation that indicates such implicit operands as an explicit micro-operation operand.

For at least one embodiment, for example, the BSPSTORE application register includes the address at which the next RSE spill will occur. While the BSPSTORE register may be an implicit operand for some traditional register window operations, the RSE 122 generates a micro-op to explicitly indicate the BSPSTORE register for such operations.

Also, for example, at least one embodiment of the BSPLOAD application register is the backing store pointer for memory loads. The bspload application register holds the backing store address that is 8 bytes greater than the next address to be loaded by the RSE. While the BSPSTORE register may be an implicit operand for some traditional register window operations, the RSE 122 generates a micro-op to explicitly indicate the BSPLOAD register for such operations.

For at least one embodiment, the RSE NaT collection register (RNAT) is a 64-bit register used by the RSE 122 to temporarily hold a type of status bits, exception deferral bits (“NaT bits”), when spilling general registers to the backing store 151 (see 151, FIG. 2). Traditionally, during spills or fills of the contents of a register to or from the backing store, the NaT bit value for that register may also be spilled/filled, although the RNAT register may be an implicit operand to the RSE spill or fill operation. For at least one embodiment of the RSE 122 illustrated in FIG. 4, the RSE generates a micro-op that explicitly names the RNAT register in order to accomplish the corresponding NaT bit operation upon a spill or fill.

The explicit indication of special registers in the micro-ops generated by the RSE 122 makes data dependencies explicit. For at least one embodiment, a result of such processing is that scheduling logic may be simplified so that implicit data dependencies need not be anticipated for such micro-ops.

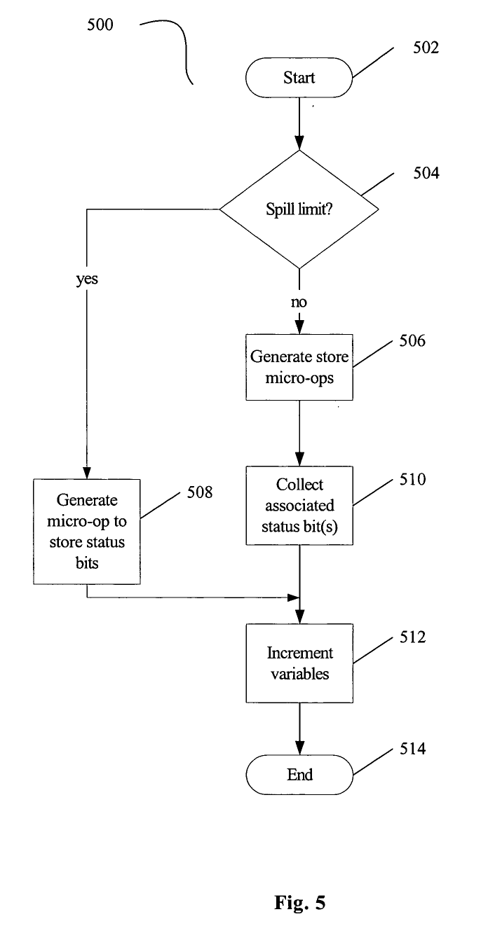

In addition to utilizing a fixed format for micro-ops and making implicit operands explicit in the micro-ops it generates, the RSE 122 also explicitly expresses sequencing using multiple micro-operations. The operation of the RSE 122 is further addressed below in connection with FIG. 5.

As is illustrated in FIG. 4, the RSE 122 determines which micro-ops are required for a particular function (spill or fill), generates micro-ops 172a-172n to implement the RSE function, and inserts such micro-ops into the instruction pipeline 300. To do so, the RSE 122 may work in conjunction with a micro-op generator 116 (see FIG. 2). For at least one embodiment, the micro-op generator 116 is included within the RSE 122. For at least one other embodiment, RSE 122 may work in conjunction with a separate micro-op generator 116 to generate micro-ops that implement the RSE spill and fill operations.

FIG. 4 illustrates, via offset placement of the micro-op generator 116, that the function of the micro-op generator may be implemented either as a part of the RSE 122 or as a separate hardware element (see, e.g., FIG. 2). In the former case, the RSE 122 directly generates micro-ops to implement RSE functions. In the latter case, the RSE 122 indirectly generates micro-ops to implement RSE functions.

Returning to FIG. 2, FIG. 2 illustrates that, for the indirect micro-op generation embodiment, the RSE may pass micro-op generation information to the micro-op generator 116. The micro-op generator 116 may then generate micro-ops on behalf of the RSE 122 and insert such micro-ops into a micro-op queue 173 along with “other” micro-ops . As used herein, “other” micro-ops are micro-ops that do not implement the RSE function but serve some other function. For instance, the “other” micro-ops may be micro-ops generated to perform instructions that do not involve the RSE 122. Such “other” micro-ops may also be referred to herein as “regular” micro-ops.

The RSE may insert, either directly or indirectly, its generated micro-ops into the micro-op queue 173 such that such micro-ops and “other” micro-ops are intermingled. That is, the scheduler 170 may consider both types of micro-ops as a single set of micro-ops that may be scheduled concurrently according to a single scheduling algorithm. In this manner, the scheduler 170 performs out-of-order scheduling for “other” micro-operations and the one or more micro-operations in an intermingled fashion.

Via placement in the micro-op queue 173, the micro-ops generated by the RSE 122 are inserted into the execution pipeline (see 300, FIG. 3). The micro-ops are then scheduled (such as, for example, by scheduler 170 in FIG. 2) for execution by one or more execution units (such as, for example, execution units 175 in FIG. 2).

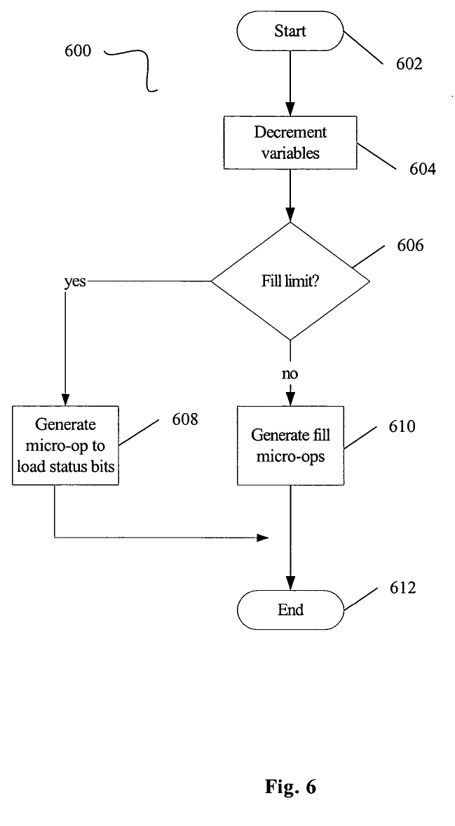

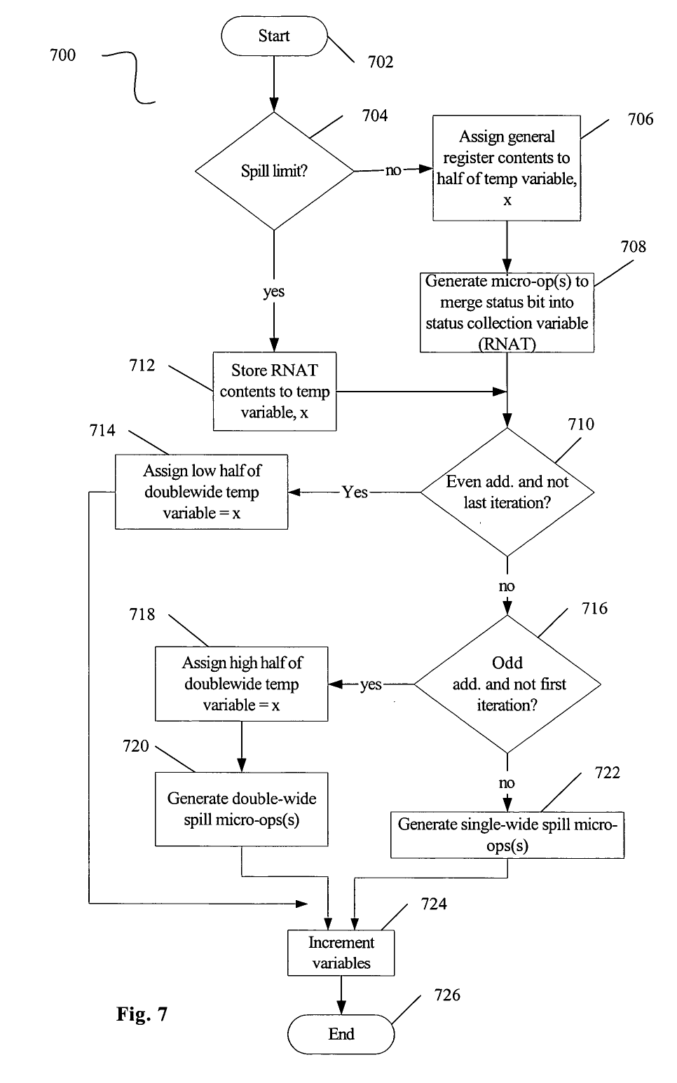

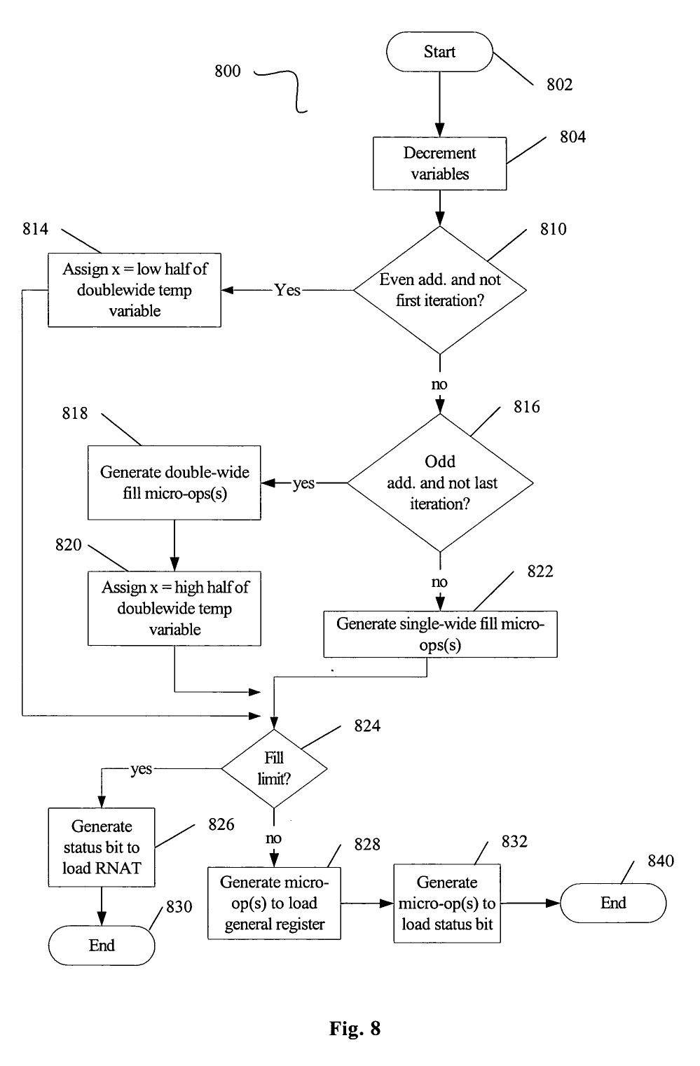

FIGS. 5-8 are flowcharts illustrating methods of generating micro-operations to implement RSE spills and fills. For at least one embodiment, the methods 500 (illustrated in FIG. 5), 600 (illustrated in FIG. 6), 700 (illustrated in FIG. 7) and 800 (illustrated in FIG. 8) are performed by a register stack engine, such as RSE 122 illustrated in FIGS. 1-4. Methods 500 and 600 may be performed for a processor that is capable of performing more than one load operation per clock cycle and more than one store operation per clock cycle. Methods 700 and 800 may be performed by a processor system utilizing a memory with a single load port and store port. For methods 700 and 800, merging may be used to drive the memory system in order to perform more than one spill or fill operation per clock cycle.

FIGS. 5 and 6 illustrate methods 500, 600 that utilize multiple copies of certain special registers, bspload and bspstore registers, to drive a memory system capable of more than one store or load operation per clock cycle. At least one embodiment of each method 500, 600 is performed by the RSE 122 to implement, respectively, the pseudo-code operations set forth in Tables 1 and 2, below. In Tables 1 and 2, the notation “bspstore%i%” denotes the i^{th} version of the bspstore register and the notation “bspload%i%” denotes the i^{th} version of the bspload register. For at least one embodiment, 0≦i<M, where M indicates the number of spill/fill operations the processor can perform in parallel.

FIGS. 7 and 8 illustrate methods 700 and 800 that utilize merging to drive a memory system having a single load port and a single store port. For at least one embodiment, the load and store ports are 128-bit ports, though one of skill in the art will recognize that other port sizes may be utilized without departing from the utility described below. At least one embodiment of each method 700, 800 is performed by the RSE 122 to implement, respectively, the pseudo-code operations set forth in Tables 3 and 4, below.

In Tables 1 through 4, below, M indicates the number of spill/fill operations the processor can perform in parallel. In various embodiments, the value of M may be 1 (1 spill/fill per clock cycle), 2 (2 spills/fills per clock cycle) or 4 (4 spills/fills per clock cycle). Of course, one of skill in the art will recognize that methods 500 and 600 may also be utilized on processors for which other values of M are supported.

Also in Tables 1 through 4, below, micro-ops generated by the RSE 122 are shown in boldface font. Such micro-ops may, as is discussed above, be stored in a micro-op queue 173 and may be forwarded to the out-of-order rename unit 106, the scheduler 170 and the execution units 175. Other operations shown in Tables 1 through 4 are carried out internally by the RSE 122.

For Tables 3 and 4, it is assumed that a global variable has been defined in order to provide a temporary holding bin for the two halves of a double-wide load or store operation. For at least one embodiment, it is assumed that a global definition for such a definition has been made according to the following pseudo-code statement: “struct {INT64 1, INT64 h} tempreg”.

TABLE 1

| 1. | void doOneSpill ( ) { | |
|---|---|---|
| 2. | bool grflag; | |
| 3. | grflag = EXTRACT (bspstore%i%, 8, 3)!=63; | |
| 4. | if (grflag) { | // store a general register |
| 5. | Store8 [bspstore%i%] = GR[storereg].value; | |
| 6. | RNAT = rnatmerge (RNAT, | |
| | GR[storereg].nat, | |
| | EXTRACT (bspstore%i%, 8, 3)); | |
| 7. | } else { | // store the RNAT register |

| | |
|---|---|
| 8. | Store8 [bspstore%i%] = RNAT; |
| 9. | }; |
| 10. | if (grflag) storereg += 1; |
| 11. | bspstore%i% += (8*M); |
| 12. | i = (i + 1) % M; |
| 13. | }; |

TABLE 2

| 1. | void doOneFill ( ) { | |
|---|---|---|
| 2. | INT64 x; | |
| 3. | bool grflag; | |
| 4. | i = (i−1) % M; | |
| 5. | bspload%i% −= (8*M); | |
| 6. | grflag = EXTRACT (bspload%i%, 8, 3)!=63; | |
| 7. | if (grflag) loadreg −= 1; | |
| 8. | if (grflag) { | // load a general register |
| 9. | Load 8 GR[loadreg].value = [bspload%i%]; | |
| 10. | GR[loadreg].nat = rnatextract (RNAT, | |
| | EXTRACT (bspload%i%, 8, 3)); | |
| 11. | } else { | // load the RNAT register |

| | |
|---|---|
| 12. | Load8 RNAT = [bspload%i%]; |
| 13. | }; |
| 14. | }; |

TABLE 3

| 1. | void doOneSpill ( ) { | |
|---|---|---|
| 2. | INT64 x; | |
| 3. | bool grflag; | |
| 4. | grflag = EXTRACT (bspstore, 8, 3)!=63; | |
| 5. | if (grflag) { | // store a general register |
| 6. | x = GR[storereg].value; | |
| 7. | RNAT = rnatmerge (RNAT, | |
| | GR[storereg].nat, | |
| | EXTRACT (bspstore, 8, 3)); | |
| 8. | } else { | // store the RNAT register |

| | |
|---|---|
| 9. | x = RNAT; |
| 10. | }; |
| 11. | if (EXTRACT (bspstore, 3)==0 && !lastiteration) { |
| 12. | tmpreg.l = x; |
| 13. | } else if (EXTRACT (bspstore, 3)==1 && !firstiteration) { |
| 14. | tmpreg.h = GR[storereg].value; |
| 15. | Store16 [bspstore & ˜8] = tmpreg; |
| 16. | } else { |
| 17. | Store8 [bspstore] = x; |
| 18. | }; |
| 19. | if (grflag) storereg += 1; |
| 20. | bspstore += 8; |
| 21. | }; |

TABLE 4

| | |
|---|---|
| 1. | void doOneFill ( ) { |
| 2. | INT64 x; |
| 3. | bool grflag; |
| 4. | bspload −= 8; |
| 5. | grflag = EXTRACT (bspload, 8, 3)!=63; |
| 6. | if (grflag) loadreg −= 1; |
| 7. | if (EXTRACT (bspload, 3)==0 && !firstiteration) { |
| 8. | x = tmpreg.l; |
| 9. | } else if (EXTRACT (bspload, 3)==1 && !lastiteration) { |
| 10. | Load16 tmpreg = [bspload & ˜8]; |
| 11. | x = tmpreg.h; |
| 12. | } else { |
| 13. | Load8 x = [bspload]; |
| 14. | }; |
| 15. | if (grflag) { // load a general register |
| 16. | GR[loadreg].value = x; |
| 17. | GR[loadreg].nat = rnatextract (RNAT, |
| | EXTRACT (bspload, 8, 3)); |
| 18. | } else { // load the RNAT register |
| 19. | RNAT = x; |
| 20. | }; |
| 21. | }; |

One skilled in the art will recognize, of course, that the pseudo-code examples provided in Tables 1 through 4 are for illustrative purposes only and should not be taken to be limiting. For example, the syntax of the micro-ops shown in Tables 1 through 4 is provided for purposes of illustration only; any syntax compatible with the execution units (see, e.g., 175 in FIG. 2) may be used for micro-ops.

Turning to FIG. 5, the method 500 illustrated in FIG. 5 is discussed herein with reference to Table 1. It is assumed that initialization of variables has occurred (not shown) prior to beginning the method 500. For instance, it is assumed that the value of storereg, a register internal to the RSE that is not architecturally visible, indicates the next register to be spilled (stored) by the RSE 122. It is also assumed that the BSPSTORE application register indicates the address of the backing store 151 (see FIG. 2) at which the next RSE spill will occur. For at least one embodiment, the address held in the BSPSTORE application register is aligned on an 8-byte boundary.

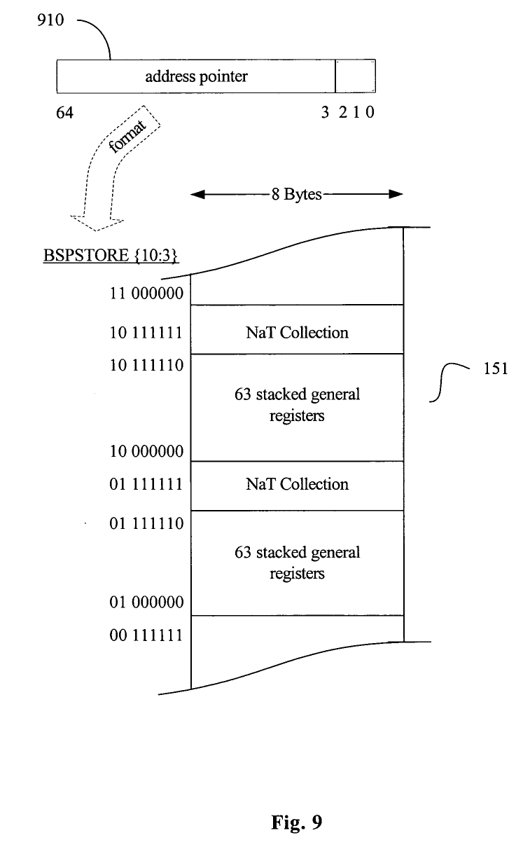

FIG. 5 illustrates that processing for method 500 begins at block 502 and proceeds to block 504. At block 504 the method 500 determines whether a register spill micro-op should be generated. To perform this determination, at least one embodiment of the method 500 assumes a particular organization of data stored in the backing store (see 151, FIG. 2). It is assumed that the backing store 151 is organized as a stack in memory that grows from lower addresses to higher addresses (see FIG. 9).

It is also assumed that status bit(s), such as the NaT bit, for a register are carried as one or more extra register bits. For example, if general registers are 64 bits in length, then the NaT bit for each register is carried in certain microarchitectural structures as an additional 65^{th} bit for the general register.

When the RSE 122 spills or fills the contents of a register, it also spills or fills the register's associated NaT bit value. The NaT bits are spilled/filled in groups of 63 after 63 consecutive spills or fills. Between the first and the 63^{rd} spills or fills, the NaT values are collected and maintained in a RSE NaT collection (RNAT) application register. That is, when the RSE 122 spills a register to the backing store, the NaT bit value associated with the spilled register is merged into the current value of the RNAT application register.

Brief reference to FIG. 9 illustrates a sample backing store 151. As is stated above, it is assumed that the backing store 151 is organized as a stack in memory that grows from lower addresses to higher addresses. When a general register is spilled to the backing store 151, its corresponding NaT bit is collected in the RSE NaT collection register (RNAT). After 63 spills to the backing store, the contents of the RNAT application register are spilled to the backing store. That is, whenever bits 8:3 of the bspstore application register all contain a value of 1b′1′, the RSE 122 stores the contents of the RNAT register to the backing store 151 as a 64^{th} entry following 63 register spills.

FIG. 9 illustrates that, for at least one embodiment, bits 0 through 2 of the bspstore register 910 are ignored (i.e., are always written as a zero), while the remaining bits hold a pointer address to the next address of the backing store 151 at which a spill will occur. Accordingly, bits 0 through 2 are ignored when determining whether the bspstore address indicates that 63 spills have occurred since the RNAT value was last stored in the backing store 151. However, one of skill in the art will recognize that such format for the bspstore register 910 should not be taken to be limiting.

For at least one alternative embodiment, no bits of the bspstore register 910 are reserved or ignored. For such embodiment, bits 0 through 2 of the bspstore register may be examined to determine whether the contents of the RNAT register should be spilled to the backing store 151. Of course, any other feasible method may also be employed to determine whether the RNAT register should be spilled. For example, a separate counter may be maintained to track the number of consecutive general register spills.

Accordingly, for at least one embodiment, the determination at block 504 of FIG. 5 is accomplished by determining whether bits 8 through 3 of the bspstore application register all contain values of 1b′1′. At least one embodiment of this determination is illustrated at lines 2-4 of Table 1. If the values of bits 8:3 are not all ones, then processing proceeds to block 506 to generate one or more spill micro-ops. Table 1 illustrates that, for at least one embodiment, whether or not the values of bits 8:3 are all ones is captured in a Boolean flag, grflag. If the grflag is true (i.e., 63 spills have not yet been performed), then a general register is to be spilled.

If, however, the value of bits 8:3 of the bspstore application register are all ones, then 63 spills have previously occurred, and it is time to store the contents of the RNAT application register to the backing store 151. In such case, processing proceeds to block 508. Line 4 of Table 1 illustrates that the value of grflag may be utilized to determine whether to proceed to block 508 or block 506 from block 504.

At block 508, one or more micro-ops are generated to spill the contents of a status bit collection register, RNAT, to the next available spill location of the backing store 151. Line 8 of Table 1 illustrates an example micro-op that may be generated at block 508. The illustrated micro-op, when executed, causes the contents of the RNAT collection register to be spilled to the location indicated by the ith copy of the BSPSTORE application register. Processing then proceeds to block 512.

If, however, it is not yet time to spill the status bit collection register, then processing proceeds from block 504 to block 506 as discussed above. At block 506 one or more micro-ops are generated to perform the spill operation to store the data contents of a general register to the backing store 151. Table 1 illustrates, at line 5, an illustrative example of such a micro-op that may be generated at block 506.

For at least one embodiment, processing proceeds from block 506 to block 510. As is true with block 508 (discussed above), block 510 is performed in embodiments where extra status bits, such as NaT bits, are tracked along with a general register. At block 510, a micro-op is generated in order to collect the status bit(s) for the appropriate general register (that is, for the register that is being spilled) into a temporary collection register, such as RNAT. Line 6 of Table 1 illustrates a sample of such a micro-op that may be generated at block 510.

For at least one embodiment, the “matmerge” micro-op that may be generated at block 510 is a read-modify-write type of instruction that writes only a single bit of the collection register, RNAT, and leaves the remaining bits undisturbed. As such the matmerge micro-op represents a bit manipulation operation. The micro-op illustrated at line 6 of Table 1 may be executed as follows.

The initial value of RNAT is read into a temporary variable; the NaT bit value associated with the general register indicated by the storereg variable is modified in the temporary variable (but all other bits remain unmodified)—this function may be accomplished with a mask; and the updated value of the temporary variable is stored back to the RNAT application register. At least one embodiment of the matmerge micro-op includes a parameter to indicate which bit of the RNAT register is to be modified. The embodiment of the matmerge micro-op set forth at line 6 of Table 1 illustrates an EXTRACT parameter to provide this information. In the illustrated matmerge micro-op, the EXTRACT statement indicates which location within a block of 63 locations is to be written for the spill. This parameter provides that the corresponding location within the 63 writable bits of the RNAT will be modified via execution of the matmerge micro-op generated at block 510.

One of skill in the art will recognize that the NaT bit is just one example of a status bit that may be tracked with a general register and collected during spill operations. Different bits may be tracked, and multiple bits may be tracked. For the case of multiple bits, at least one embodiment of method 500 collects each of the status bits in a separate collection register via micro-ops generated at block 510. Accordingly, for such embodiment, a collection micro-op such as that illustrated at line 6 of Table 1 is generated at block 510 for each of the status bit collection registers. Processing then proceeds to block 512.

At block 512, variables are post-incremented in anticipation of a future pass through the method 500. Line 11 of Table 1 illustrates that, for at least one embodiment, one architecturally visible register, bspstore%i% is incremented via a micro-op. Execution of this micro-op results in an increment of the contents of the appropriate version (i.e., the i^{th}) of the bspstore application register so that, during the next iteration of the method 500, the appropriate version of the bspstore application register includes the address of the backing store address at which the next RSE spill will occur. Internal variables, such as i and storereg, are also incremented at block 512 via internal operations of the RSE 122, as illustrated at lines 10 and 12 of Table 1. For at least one embodiment, storereg is incremented only if a general register, rather than the status bit collection register (RNAT), was processed during the current pass through the method 500. Processing then ends at block 514.

FIG. 6 illustrates a method for generating fill micro-ops for a processing system capable of executing multiple load instructions per clock cycle. The method 600 illustrated in FIG. 6 is discussed herein with reference to Table 2. As with the method 500 discussed above, it is assumed that initialization of variables has occurred (not shown) prior to beginning the method 600. For instance, it is assumed that loadreg and i contain meaningful values. For at least one embodiment, for example, it is assumed that loadreg holds the physical register number that is one greater than the next physical register to load.

Also, it is assumed that the bspload application register holds a meaningful value. For at least one embodiment, the bspload application register is the backing store pointer for memory loads. The bspload application register holds the backing store address that is 8 bytes greater than the next address to be loaded by the RSE.

FIG. 6 illustrates that processing for method 600 begins at block 602 and proceeds to block 604. At block 604, variables (which may have been post-incremented after spill micro-ops were generated according to the method 500 shown in FIG. 5) are pre-decremented in preparation for generating a micro-op to restore a previously-stored value from the backing store 151 (FIGS. 1 and 2) to a general purpose register. Decrementing 604 may occur for variables internal to the RSE 122 as well as for architecturally-visible register values. Regarding internal variables, for example, the value of i may be decremented. An example of an RSE-internal pseudo-code instruction to accomplish a pre-decrement of i is set forth at line 4 of Table 2. Also, the loadreg address may be pre-decremented. An example of an RSE-internal pseudo-code instruction to accomplish a pre-decrement of the loadreg value is set forth at line 7 of Table 2. For at least one embodiment, the pre-decrement of the loadreg value is only performed if a general register value, rather than an RNAT value, is to be loaded from the backing store during the current iteration of the method 600.

In addition, at block 604, a micro-op may be generated to decrement the value in the architecturally-visible bspload application register. An illustrative example of a bspload pre-decrement micro-op that may be generated at block 608 is set forth at line 5 of Table 3, above. Processing then proceeds to block 606.

At block 606 the method 600 determines whether a register fill micro-op should be generated. To perform this determination, at least one embodiment of the method 600 assumes the organization of a backing store 151 as discussed above in connection with FIG. 9.

Accordingly, for at least one embodiment, the determination at block 606 is accomplished by determining whether bits 8 through 3 of the bspload application register all contain values of 1b′1′. At least one embodiment of this determination is illustrated at lines 3, 6, 7 and 8 of Table 2, which show that a Boolean flag (grflag) reflects whether or not the values of bits 8:3 of bspload includes all ones. If the value of bits 8:3 are not all ones, then processing proceeds to block 610 to generate one or more fill micro-ops. Otherwise, processing proceeds to block 608 (see example “else” instruction at line 12 of Table 2).

If the values of bits 8:3 of the bspload application register are all ones, then it is time to load the stored contents of the RNAT application register from the backing store 151. In such case, the value of grflag is false, and processing proceeds to block 608.

At block 610 one or more micro-ops are generated to perform the fill operation. Table 2 illustrates, at lines 9 and 10, illustrative examples of such a micro-ops that may be generated at block 610. The sample micro-op set forth at line 9 of Table 2 is a load micro-op that may be generated at block 610 to load the value of a general register from the backing store address indicated by the ith version of bspload into the “value” field for general register indicated by the internal loadreg register.

The sample micro-op set forth at line 10 of Table 2 is a load micro-op that may also be generated at block 610. When executed, the load micro-op illustrated at line 10 of Table 2 loads the appropriate status bit from the status bit collection register (RNAT) into the “nat” field for the general register indicated by the internal loadreg register. The micro-op extracts the appropriate status bit value from the RNAT collection register, based on the value of bits 8:3 of the current address reflected in the i^{th} version of the bspload register.

Accordingly, the micro-ops generated at block 610 merge the appropriate status bit from the RNAT register with the stored register value from the backing store into the appropriate general register. In this manner, 64 data bits from the backing store in memory are loaded into the appropriate general purpose register. Also loaded for the same general purpose register is the additional status bit(s) tracked in a separate register, such as the RNAT register, during a previous spill operation. From block 610, processing ends at block 612.

FIG. 6 illustrates that, if 63 fills have been performed since the last RNAT value has been loaded from the backing store 151 (FIGS. 1 and 2), then processing proceeds from block 606 to block 608. At block 608, a micro-op is generated to load the previously-stored RNAT value from the current address of the backing store, as indicated by the appropriate version of the bspload application register, into the RNAT status bit collection register. An example of such a micro-op that may be generated at block 608 is set forth at line 12 of Table 2. From block 608, processing ends at block 612.

In contrast to the multiple-operation embodiments 500, 600 discussed above, the spill and fill method embodiments 700, 800 shown in FIGS. 7 and 8, respectively, do not anticipate multiple store or load operations per cycle. As such, the methods 700, 800 do not utilize the M variable because M is implicitly assumed to be one. Similarly, because only one such operation is anticipated per cycle, a single copy of the bspstore and bspload registers are utilized. Accordingly, the i variable is not utilized.

Instead, methods 700 and 800 illustrated in FIGS. 7 and 8 assume a memory system 150 (see FIG. 1, FIG. 2) that provides a single extended memory port. For at least one embodiment, methods 700 and 800 assume a single store port (method 700) and a single load port (method 800) that are each 128 bits wide. That is, each can accommodate a double-wide load or store operation. As such, the 128-bit ports accommodate two 64-bit spill or fill operations to be processed in a single cycle by a single port. A temporary register, tmpreg, is used to store each of the two spill or fill values for the single spill or fill operation. Of course, one of skill in the art will recognize that, for embodiments having a wider port or utilizing smaller load and store values, more than two spill or fill values may be processed with each operation.

The spill method 700 for such an embodiment is discussed herein with reference to FIG. 7 and Table 3. FIG. 7 illustrates that processing for method 700 begins at 702 and proceeds to block 704. As with the methods 500, 600 discussed above, method 700 determines 704 whether a register fill micro-op should be generated. To perform this determination 704, at least one embodiment of the method 700 assumes the organization of a backing store 151 as discussed above in connection with FIG. 9.

Accordingly, for at least one embodiment, the determination at block 704 is accomplished by determining whether bits 8 through 3 of the bspstore application register all contain values of 1b′1′. At least one embodiment of this determination is illustrated at lines 3, 4 and 5 of Table 3. The Boolean grflag reflects whether the values of bits 8:3 of the bspstore application register do not equal all ones. If the value of bits 8:3 of the bspstore application register are not all ones, then the grflag value is true and processing proceeds to block 706.

If, however, the value of bits 8:3 of the bspstore application register are all ones, then the value of grflag is false. It is thus time to load the stored contents of the RNAT application register from the backing store 151 back into the RNAT. In such case, processing proceeds to block 712.

At block 706, an internal RSE instruction is generated to store the contents of the general register indicated by the internal storereg variable into a single-wide temporary variable, x. An example of such an instruction generated at block 706 is set forth at line 6 of Table 3. Processing then proceeds to block 708.

At block 708, a micro-op is generated to collect the status bit(s) for the appropriate general register (that is, for the register that is being spilled) in a temporary collection register. Line 7 of Table 3 illustrates a sample of such a micro-op that may be generated at block 708.

For at least one embodiment, the “rnatmerge” micro-op that may be generated at block 708 is a read-modify-write type of instruction that writes only a single bit of the collection register, RNAT, and leaves the remaining bits undisturbed. The micro-op illustrated at line 7 of Table 3 may be executed as follows. The initial value of RNAT is read into a temporary variable; the NaT bit value associated with the general register indicated by the storereg variable is modified in the temporary variable (but all other bits remain unmodified)—this function may be accomplished with a mask; and the updated value of the temporary variable is stored back to the RNAT application register.

At least one embodiment of the matmerge micro-op includes a parameter to indicate which bit of the RNAT register is to be modified. The embodiment of the matmerge micro-op set forth at line 7 of Table 3 illustrates a third parameter to provide this information. In the illustrated matmerge micro-op, the third parameter is provided by an EXTRACT statement that indicates which location within a block of 63 locations is to be written for the spill. This parameter provides that the corresponding location within the 63 writable bits of the RNAT will be modified via execution of the matmerge micro-op generated at block 510.

For at least one other embodiment, the third parameter of the matmerge micro-op illustrated at block 708 may indicate an internal variable, such as RNATBitIndex, that automatically maintains the value of the bits 8:3 of the current bspstore value.

From block 708, processing proceeds to block 710. At block 710 a determination is made regarding the current value in the bspstore register to determine whether bits 8:3 of the bspstore register reflects an even address value, or an odd address value. For an embodiment where the value in bspstore is always on an 8-byte boundary, this determination is made by evaluating only bit 3 of the bspstore value, to determine whether it is a zero or a one.

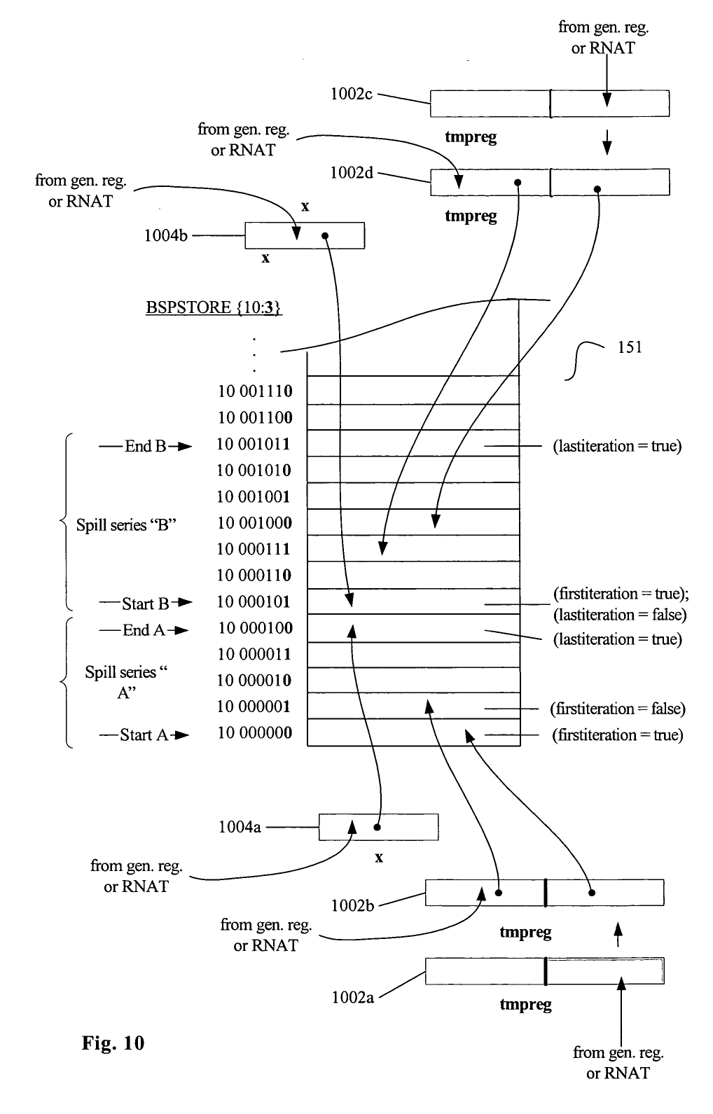

Additional processing of the method 700, as reflected at blocks 710 and 716, is further discussed with reference to FIG. 10. FIG. 10 illustrates that, due to prior spill and/or fill sequences, the current bspstore value may be either an even address (Start A) or an odd address (Start B). That is, the first pass through method 700 for a series spill operations may occur when bit 3 of the bspstore application register is zero (Start A) or when bit 3 of the bspstore application register is one (Start B).

The processing of block 710 assumes that the RSE, before invoking the doOneSpill code the first time for a series of spill operations, sets a firstiteration flag to a “true” value and the lastiteration flag to a “false” value. If the last iteration of the method 700 for a series of spill operations occurs when bit 3 of the address in bspstore is a “zero,” then only one-half of a double-wide store operation should be performed. Such situation is illustrated by “Spill series A” in FIG. 10. Similarly, if the first iteration of the method 700 for a series of spill operations occurs when bit 3 of the address in bspstore is a “one”, then it is assumed that a first half of a double-wide store operation has already occurred during a previous set of (odd-numbered) spill operations. Such situation is illustrated by “Spill series B” in FIG. 10. Each of these situations is evaluated at blocks 710 and 716, respectively, and is handled at block 722.

Accordingly, FIG. 7 illustrates that the first of a series of evaluations is performed at block 710. At block 710 it is determined whether bit 3 of the bspstore indicates an even address (i.e., reflects a value of 1b′0′) AND the lastiteration flag is not true. If so, then processing proceeds to block 714 , otherwise processing proceeds to block 716.

At block 716, it is determined whether bit 3 of the bspstore application register indicates an odd address (i.e., reflects a value of 1b′1′) AND the firstiteration flag is not true. If so, processing proceeds to block 718. Otherwise, processing proceeds to block 722.

The processing of blocks 710-722 is further discussed in conjunction with the example set forth in FIG. 10. FIG. 10 illustrates that, on the first pass method 700 for “Spill series A,” the firstiteration flag is true and bit 3 of the bspstore register indicates an even address. Accordingly, processing proceeds to block 714. At block 714, the first (lower) half of a double-wide temporary variable, tmpreg, is assigned to the value of x. The current value of x (whether it is general register data assigned at block 706 or contents of the RNAT assigned at block 712) is thus stored in half of the double-wide temporary variable (see 1002a in FIG. 10). A sample pseudo-code instruction that may be generated at block 714 to assign the first half of the tempreg variable to the value of x is set forth at line 12 of Table 3.

On the next pass of method 700 for “Spill series A,” it is presumed that the lastiteration flag and firstiteration flag are both false, as set by the RSE before invoking the method 700. On the second pass, bspstore holds an odd address, and firstiteration is not true. Accordingly, the determination at block 716 evaluates to “true”, and processing proceeds to block 718.

At block 718, the second (high) half of the tmpreg temporary variable is assigned to the current value of x (which, again, reflects either general register data or the contents of the RNAT). An example of a pseudo-code instruction to effect this assignment is set forth at line 14 of Table 3. The effect of this assignment is illustrated at 1002b in FIG. 10.

From block 718, processing then proceeds to block 720, where one or more double-wide spill micro-ops is generated to perform the double-wide spill to the backing store 15 1. An example of a micro-op that may be generated at block 720 is set forth at line 15 of Table 3. Because the spill (Store) micro-op indicates a double-wide load operation, the value of bspstore is incremented in order to account for the additional backing store entry that has been processed during the current iteration. Accordingly, the Store 16 micro-operation increments the bspstore address. For at least one embodiment, this increment is performed by zero-ing out bit three of the address held in bspstore. The sample micro-op set forth at line 16 of Table 3 indicates that this may be accomplished by performing a Boolean AND of the bspstore address and the complement of the hexadecimal value “8” to mask out bit 3 to a value of zero. Accordingly, on the first and second pass of the method 700 for “Spill series A”, internal instructions are generated to collect the first and second halves of the temporary value, tmpreg. On the second iteration of the method 700, the low and high halves of tmpreg are stored to the backing store in a single cycle, effectively writing two entries into the backing store 151 during a single cycle.

However, one can see that there are an odd number of spill operations designated for “Spill series A.” The task of generating a micro-op to store the final single-wide spill data to the backing store 151 is handled as follows. During the final pass through the method 700 for “Spill series A”, it is determined that neither condition tested at blocks 710 and 716 is true. That is, bspstore holds an even address and lastiteration is true. Accordingly, processing proceeds to block 722.

At block 722 a micro-op is generated to store the single-wide data value in the temporary variable, x, to the backing store 151 (see 1004a in FIG. 10). An example of a micro-op that may be generated at block 722 is set forth at line 17 of Table 3.

The processing of blocks 710-722 is now further discussed in conjunction with the “Spill series B” example set forth in FIG. 10. FIG. 10 illustrates that, on the first pass of method 700 for “Spill series B,” the bspstore hold an odd address and firstiteration is true. Accordingly, the determinations at blocks 710 and 716 evaluate to “false” and processing thus proceeds to block 722. At block 722, a micro-op is generated (see line 17 of Table 3) to spill the single-wide spill data from the temporary variable x (see 1004b) to the backing store 151.

On subsequent iterations of method 700 for “Spill series B”, double-wide spills are effected via the processing discussed above for blocks 710-720 (see, e.g., 1002c and 1002d of FIG. 10).

From blocks 714, 720 and 722, processing proceeds to block 724. At block 724, variables are post-incremented. For at least one embodiment, both internal and external variables are incremented. Line 20 of Table 3 illustrates a micro-op that may be generated at block 724 in order to post-increment the architecturally-visible bspstore application register. In addition, line 19 of Table 3 illustrate an example instruction that may cause the internal variable storereg to be incremented if grflag is true; a true value for grflag indicates that a general register (rather than the RNAT) was spilled during the current iteration of the method 700. Otherwise, if the RNAT was spilled (i.e., grflag=false) then storereg is not incremented. From block 724, processing for the method 700 ends at block 726.

The fill method 800 for a single-port embodiment is discussed herein with reference to FIG. 8 and Table 4. As with the other methods discussed above, it is assumed that initialization of variables has occurred (not shown) prior to beginning the method 800. For instance, it is assumed that loadreg, the bspload application register, and RNAT contain meaningful values.

FIG. 8 illustrates that processing for method 800 begins at block 802 and proceeds to block 804. At block 804, the value of variables (which may have been post-incremented after spill micro-ops were generated according to the method 700 shown in FIG. 7) are pre-decremented in preparation for generating a micro-op to restore a previously-stored value from the backing store 151 (FIGS. 1 and 2) to a general purpose register (or the RNAT).

Decrementing 804 may occur for variables internal to the RSE 122 as well as for architecturally-visible register values. Regarding internal variables, the value of loadreg may be decremented. An example of an RSE-internal pseudo-code instruction to accomplish a pre-decrement of loadreg is set forth at line 6 of Table 4. For at least one embodiment, loadreg is decremented only if grflag is true; a “true” value in grflag indicates that a general register (rather than the RNAT collection register) is to be filled (see lines 3 and 5 of Table 4).

In addition, at block 804, a micro-op may be generated to decrement the value in the architecturally-visible bspload application register. An illustrative example of a bspload pre-decrement micro-op that may be generated at block 804 is set forth at line 4 of Table 4, above. Processing then proceeds to block 810.

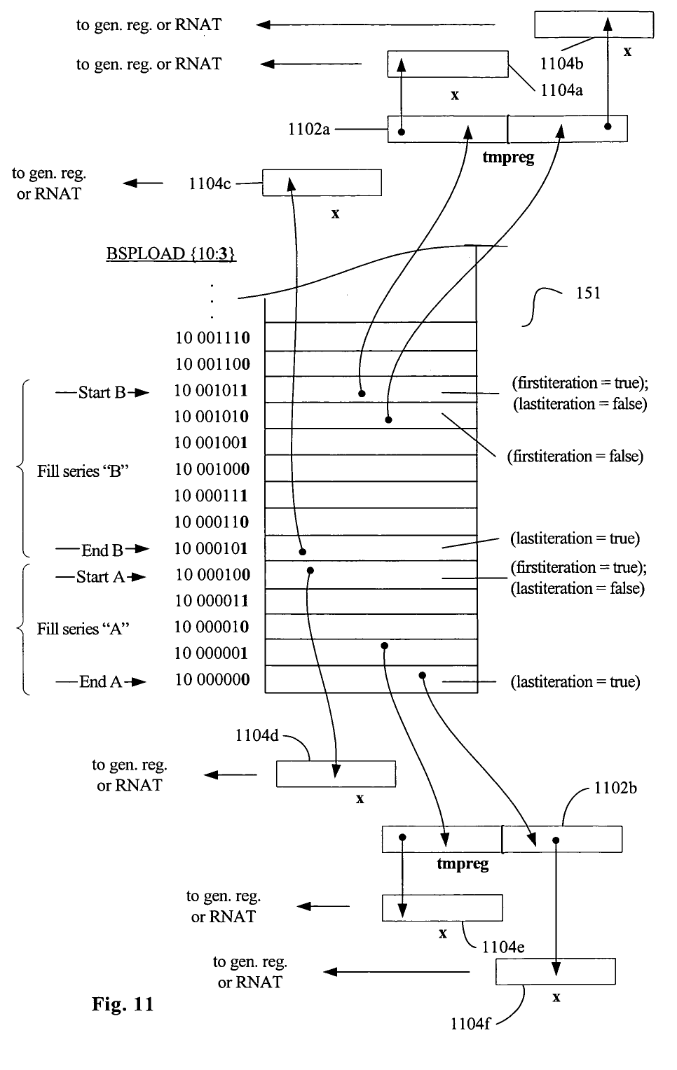

Further processing of method 800 will be discussed in conjunction with the example set forth in FIG. 11. FIG. 11 illustrates that fills from the backing store 151, which is implemented as a stack, are performed from higher addresses down to lower addresses. Accordingly, those values spilled during “Spill series B” are filled from the backing store before filling the values spilled during “Spill series A.” Accordingly, on a first pass of method 800, it is assumed that the last value spilled during “Spill series B” is the first value to be filled from the backing store.

During a series of passes through method 800, the following occurs. In most cases, a double-wide load instruction is performed to bring two fill values from the backing store 151 into a temporary variable, tmpreg. A temporary value, x, is assigned to hold the particular value, from either the low half or high half of tmpreg, that is to be filled into either a general register or the RNAT register. A micro-op is then generated to perform the fill. On a next pass through the method, no load from the backing store is necessary. Instead, x is assigned the value of the remaining half of the tmpreg value. In cases where an odd number of spills previously occurred, the odd fill data is loaded directly into x from the backing store 151 via a single-wide load instruction. Such processing is discussed in further detail below in connection with FIGS. 8 and 11.

FIG. 11 illustrates an example of operation of method 800 when spills have previously occurred according to the example set forth in FIG. 10. FIG. 11 illustrates that, on a first pass of method 800, bit 3 of the bspload address is odd, firstiteration is true, and lastiteration is false. Accordingly, the determination at block 810 evaluates to “false” and the determination at block 816 evaluates to “true.” Processing thus proceeds to block 818.

At block 818, one or more micro-ops are generated to perform a double-wide load from the backing store 151 into tmpreg. An example of such a micro-op that may be generated at block 818 is set forth at line 10 of Table 4. As a result of execution of such micro-op, two pieces of fill data are retrieved into tmpreg in a single cycle (see 1102a, FIG. 11).

Because the load micro-op indicates a double-wide load operation, the value of bspload should be decremented in order to account for the additional backing store entry that has been processing during the current iteration. Accordingly, the Load 16 instruction decrements the bspload address to point to the last position loaded. For at least one embodiment, this decrement is performed by zero-ing out bit three of the address held in bspload. The sample micro-op set forth at line 10 of Table 4 indicates that this may be accomplished by performing a Boolean AND of the bspload address and the complement of the hexadecimal value “8” to mask out bit 3 to a value of zero. Processing then proceeds to block 820.

At block 820, data from the appropriate half of tmpreg is moved to x, a single-wide temporary variable. Because fills are performed in reverse order from spills, the second (high) half of tmpreg is filled before the first (low) half is filled. Accordingly, on a first pass of method 800 for “Fill series B,” at block 820 x is assigned the value of the second half of tmpreg (see 1104a, FIG. 11). A sample instruction for performing such assignment is set forth at line 11 of Table 4. Processing then proceeds to block 824, which is discussed below.

For a second mass of method 800 during the “Fill series B” example illustrated in FIG. 11, bit 3 of the bspload value, after the pre-decrement at block 804, reflects an even address and firstiteration is false. Accordingly, the determination at block 810 evaluates to “true,” and processing proceeds to block 814.

At block 814, a micro-op is generated in order to move data from the appropriate half of tmpreg to x, the single-wide temporary variable. Because the second (high) half of tmpreg was already filled during an earlier pass of method 800, at block 820, the first (low) half is tmpreg is now filled. Accordingly, on a second pass of method 800 for “Fill series B,” at block 814 x is assigned the value of the first (low) half of tmpreg (see 1102a, FIG. 11). A sample instruction for performing such assignment is set forth at line 8 of Table 4. Processing then proceeds to block 824, which is discussed below.

For a final pass of method 800 during the “Fill series B” example illustrated in FIG. 11, bit 3 of bspload value, after the pre-decrement at block 804, reflects an odd address and lastiteration is true. Accordingly, the determinations at block 810 and 816 evaluate to “false” and processing proceeds to block 822.

At block 822, a micro-op is generated in order to load a single-wide store value from the current address indicated by bspload into the single-wide temporary variable, x (see 1104c, FIG. 11). An example of a micro-op that may be generated at block 822 is set forth at line 13 of Table 4. As a result of execution of such micro-op, a single-wide value is loaded from the backing store location indicated by bspload into x. In this manner, the last fill from an odd-numbered spill series is loaded on a final iteration of the method 800.

One will note that, because the load micro-op at line 13 of Table 4 is a single-wide operation, the bspload value need not be modified as was done at line 10 of Table 4 for the double-wide load micro-op. From block 822, processing proceeds to block 824, which is discussed below.

The processing of blocks 810-822 is now further discussed in conjunction with the “Fill series A” example set forth in FIG. 11. FIG. 11 illustrates that, on the first pass of method 800 for “Fill series A,” bit 3 of bspload indicates an even address and firstiteration is true. Accordingly, the determinations at blocks 810 and 816 evaluate to “false” and processing thus proceeds to block 822. At block 822, a micro-op is generated (see line 13 of Table 4) to fill single-wide spill data from location of the backing store indicated by bspload to the temporary variable x (see 1104d).

On subsequent iterations of method 800 for “Fill series A”, double-wide spills are effected via the processing discussed above for blocks 810-820 (see, e.g., 1102b, 1104e and 1104f of FIG. 11).

After the value of x has been assigned at block 814, 820 or 822, processing proceeds to block 824. At block 824, it is determined whether the value of x , which was loaded from the backing store, should be loaded to a general register or to the RNAT. If 63 fills have been performed since the last RNAT load, then it is again time to load the RNAT. Accordingly, it is determined at block 824 whether 63 fills have occurred since the last RNAT fill. If so, then processing proceeds to block 826. Otherwise processing proceeds to block 828.

For at least one embodiment, the determination at block 824 is performed by evaluating a Boolean variable. The pseudo-code instructions set forth at lines 3, 5 and 16 illustrate such an embodiment. As with the other methods 500, 600, 700 discussed above, at least one embodiment of the method 800 assumes the organization of a backing store 151 as discussed above in connection with FIG. 9.

Accordingly, for at least one embodiment, the determination at block 824 is accomplished by determining whether bits 8 through 3 of the bspload application register all contain values of 1b′1′. At least one embodiment of this determination is illustrated at lines 3 and 5 of Table 4. The Boolean grflag reflects whether the values of bits 8:3 of the bspload application register do not equal all ones. If the values of bits 8:3 of the bspload application register are not all ones, then the grflag value is true and processing proceeds to block 828.

If, however, the value of bits 8:3 of the bspstore application register are all ones, then the value of grflag is false, which means that the current location of the backing store, as represented by the address in bspload, includes status bits associated with the next fills that are to occur. It is thus time to load the stored contents of the RNAT application register from the backing store 15 1. In such case, processing proceeds to block 826.

At block 828, one or more micro-ops are generated which, when executed, cause the value of x to be loaded into the data portion of a general register. An example of a micro-op that may be generated at block 828 is set forth at line 16 of Table 4. Processing then proceeds to block 832.

At block 832, one or more micro-ops are generated which, when executed, cause the value of the appropriate bit of the RNAT collection register to be loaded into the status bit tracked with the general register being filled. For at least one embodiment, the appropriate value of the RNAT collection register is isolated via an matextract micro-operation that indicates the RNAT collection register as an explicit operand. The matextract operation is a logical bit manipulation operation. An example of such a micro-op that may be generated at block 832 is set forth at line 17 of Table 4.

The example micro-op illustrates that the matextract operation receives as parameters the RNAT register and an EXTRACT parameter. The EXTRACT parameter provides bits 8:3 of the bspload register. In this manner, the bit of the RNAT register that is associated with the nth fill in a series of fills is identified, where 1≦n≦63. Processing then ends at block 840.

If it is determined at block 824 that 63 general register fills have been performed since the last RNAT fill, then processing proceeds to block 826 in order to perform an RNAT fill. At block 826, a micro-op is generated to assign the value of x to RNAT. In this manner, the RNAT register is filled from the backing store 151. An example of such a micro-op that may be generated at block 834 is set forth at line 19 of Table 4. Processing then ends at block 830.

The foregoing discussion discloses selected embodiments of an apparatus, system and method for implementing a register stack using micro-operations. The methods described herein may be performed on a processing system such as the processing systems 100, 100a illustrated in FIGS. 1 and 2.

FIGS. 1 and 2 illustrate embodiments of processing systems 100, 100a, respectively, that may utilize disclosed techniques. Systems 100, 100a may be used, for example, to execute one or more methods for implementing a register stack engine using micro-operations, such as the embodiments described herein. For purposes of this disclosure, a processing system includes any processing system that has a processor, such as, for example; a digital signal processor (DSP), a microcontroller, an application specific integrated circuit (ASIC), or a microprocessor. Systems 100 and 100a are representative of processing systems based on the Itanium® and Itanium® 2 microprocessors as well as the Pentium®, Pentium®) Pro, Pentium(g) II, Pentium(® III, and Pentium® 4 microprocessors, all of which are available from Intel Corporation. Other systems (including personal computers (PCs) having other microprocessors, engineering workstations, personal digital assistants and other hand-held devices, set-top boxes and the like) may also be used. At least one embodiment of system 100 may execute a version of the Windows™ operating system available from Microsoft Corporation, although other operating systems and graphical user interfaces, for example, may also be used.

Processing systems 100 and 100a include a memory system 150 and a processor 101, 101a. Memory system 150 may store instructions 140 and data 141 for controlling the operation of the processor 101. Data space 141 of memory 150 may also include a backing store 151 to store the contents of registers spilled in order to maintain register windows.

Memory system 150 is intended as a generalized representation of memory and may include a variety of forms of memory, such as a hard drive, CD-ROM, random access memory (RAM), dynamic random access memory (DRAM), static random access memory (SRAM), flash memory and related circuitry. Memory system 150 may store instructions 140 and/or data 141 represented by data signals that may be executed by the processor 101, 101a.

In the preceding description, various aspects of a method, apparatus and system for implementing a register stack using micro-operations are disclosed. For purposes of explanation, specific numbers, examples, systems and configurations were set forth in order to provide a more thorough understanding. However, it is apparent to one skilled in the art that the described method and apparatus may be practiced without the specific details. It will be obvious to those skilled in the art that changes and modifications can be made without departing from the present invention in its broader aspects. While particular embodiments of the present invention have been shown and described, the appended claims are to encompass within their scope all such changes and modifications that fall within the true scope of the present invention.

1. An apparatus comprising:
a register stack engine to trigger memory operations in support of register windows;
the register stack engine further to generate one or more micro-operations to perform a register window operation.

2. The apparatus of claim 1, wherein:
the register stack engine is further to insert the one or more micro-operations into an execution pipeline.

3. The apparatus of claim 1, wherein:
the register window operation is a spill operation.

4. The apparatus of claim 3, wherein:
the one or more micro-operations include a store micro-operation.

5. The apparatus of claim 1, wherein:
the register window operation is a fill operation.

6. The apparatus of claim 5, wherein the one or more micro-operations include a load micro-operation.

7. The apparatus of claim 1, wherein:
the register stack engine is further to generate the micro-operations indirectly, via a micro-op generator.

8. The apparatus of claim 2, wherein:
the register stack engine is further to insert the one or more micro-operations into the execution pipeline indirectly, via a micro-op generator.

9. The apparatus of claim 2, further comprising:
a micro-operation queue;
wherein inserting the one or more micro-operations into the execution pipeline further comprises inserting the micro-operations into the micro-operation queue.

10. The apparatus of claim 1, wherein:
the register window operation is associated with an implicit operand; and
the one or more micro-operations includes a micro-operation that indicates the implicit operand as an explicit operand.

11. The apparatus of claim 10, wherein:
the implicit operand is a status bit collection register.

12. The apparatus of claim 10, wherein:
the implicit operand is a store pointer register.

13. The apparatus of claim 10, wherein:
the implicit operand is a load pointer register.

14. The apparatus of claim 1, further comprising:
a scheduler to schedule the micro-operations for execution;
wherein the scheduler is to concurrently consider the register window operation micro-operations as well as other micro-operations in an out-of-order scheduling scheme.

15. The apparatus of claim 1, wherein:
each of the micro-operations is of a format that includes a single explicit destination operand and two explicit source operands.

16. A system comprising:
a memory to store an instruction, the memory including a backing store to store one or more spilled values; and
a processor coupled to the memory;
wherein the processor includes a register stack engine to generate, responsive to the instruction, one or more micro-operations to cause a register stack operation.

17. The system of claim 16, wherein:
the memory is a DRAM.

18. The system of claim 16, wherein:
the processor further includes an architectural renamer to rename registers to support register windowing.

19. The system of claim 16, wherein:
the processor further includes an out-of-order rename unit to map logical registers to physical registers in order to increase parallelism.

20. The system of claim 16, wherein:
the register stack operation is a spill operation.

21. The system of claim 16, wherein:
the register stack operation is a fill operation.

22. The system of claim 16, wherein:
the processor further includes a scheduler to perform out-of-order scheduling for a set of micro-operations, wherein the set of micro-operations includes a regular micro-operation and also includes the one or more micro-operations to cause a register stack operation.

23. The system of claim 22, wherein:
the scheduler considers the set of micro-operations for out-of-order scheduling such that the regular micro-operation and the one or more micro-operations are scheduled in an intermingled fashion.

24. A method comprising:
performing an architectural rename stage for an instruction, in order to support register windowing; and
performing an out-of-order rename stage for each of the one or more micro-operations.

25. The method of claim 24 wherein:
the instruction is a procedure call instruction to invoke a new procedure; and
performing an architectural rename stage further comprises renaming physical register operands for a current procedure such that output registers for the current procedure are identified as input registers for the new procedure

26. The method of claim 24 wherein:
performing an architectural rename stage further comprises renaming a first input register to a predetermined physical register number.

27. The method of claim 24, further comprising:
generating one or more micro-operations to implement the instruction.

28. The method of claim 27 wherein:
generating one or more micro-operations further comprises generating a micro-op to perform a desired memory operation.

29. The method of claim 27 wherein:
generating one or more micro-operations further comprises generating a micro-op to perform an arithmetic operation associated with a register stack engine (“RSE”) operation.

30. The method of claim 27 wherein:
generating one or more micro-operations further comprises generating a micro-op to perform a bit manipulation operation associated with a register stack engine (“RSE”) operation.

31. The method of claim 24 wherein:
performing an out-of-order rename stage further comprises mapping an architectural register to a physical rename register in order to minimize data dependencies.

32. A method, comprising:
generating one or more micro-operations to perform a RSE operation; and
inserting the one or more micro-operations into an execution pipeline;
wherein the RSE operation is to support register windowing.

33. The method of claim 32, wherein:
the RSE operation is a spill operation; and
generating one or more micro-operations further comprises generating a store micro-operation.

34. The method of claim 33, wherein:
generating a store micro-operation further comprises generating a store micro-operation to store data associated with the spill operation to a backing store in a memory.

35. The method of claim 32, wherein:
generating one or more micro-operations further comprises generating a micro-operation to operate on an implicit operand.

36. The method of claim 35, wherein:
generating one or more micro-operations further comprises generating a micro-operation to perform an arithmetic operation on an implicit operand.

37. The method of claim 35, wherein:
generating one or more micro-operations further comprises generating a micro-operation to perform a bit-manipulation operation on an implicit operand.

38. The method of claim 35, wherein:
the implicit operand is a status bit collection register.

39. The method of claim 35, wherein:
generating a micro-operation to operate on an implicit operand further comprises generating a micro-operation to collect a status bit into the implicit operand.

40. The method of claim 35, wherein:
generating a micro-operation to operate on an implicit operand further comprises generating a micro-operation to restore a status bit value from the implicit operand.

41. The method of claim 32, wherein:
the RSE operation is a fill operation; and
generating one or more micro-operations further comprises generating a load micro-operation.

42. The method of claim 41, wherein:
generating a load micro-operation further comprises generating a load micro-operation to load data associated with the fill operation from a backing store in a memory into a register.

43. The method of claim 32, wherein:
the RSE operation is a spill operation; and
generating one or more micro-operations further comprises generating a micro-operation to assign data associated with the spill operation to one half of a double-wide data register.

44. The method of claim 43, further comprising:
generating one or more micro-operations to store the contents of the double-wide data register to a backing store.

45. The method of claim 43, wherein generating one or more micro-operations further comprises:
determining whether a pre-determined number of prior spill operations has been performed;
if not, generating a micro-operation to assign general register data to the one half of a double-wide data register value; and
otherwise, generating a micro-operation to assign status data to the one half of the double-wide data register.

46. The method of claim 45, further comprising:
if the pre-determined number of prior spill operations has not been performed, generating a micro-operation to merge a status bit into a status collection variable.

47. The method of claim 45, further comprising:
generating one or more additional micro-operations to perform a second spill operation;
wherein generating the one or more additional micro-operations includes:
generating a micro-operation to assign general register data to the other half of the double-wide data register; and
generating a micro-operation to store the double-wide data register value to a backing store.

48. The method of claim 47, wherein generating one or more additional micro-operations further comprises:
generating the micro-operation to assign general register data to the other half of the double-wide data register only if a predetermined number of prior spill operations has occurred;
otherwise, generating a micro-operation to assign status data to the other half of the double-wide data register.

49. The method of claim 32, wherein:
the RSE operation is a fill operation; and
generating one or more micro-operations further comprises generating a micro-operation to obtain a double-wide data value from a backing store.

50. The method of claim 49, further comprising:
generating one or more micro-operations to assign one half of the double-wide data value to a general register.

51. The method of claim 49, further comprising:
generating one or more micro-operations to assign one half of the double-wide data value to a status bit collection register.

52. The method of claim 49, wherein generating one or more micro-operations further comprises:
determining whether a pre-determined number of prior fill operations has been performed;
if not, generating a micro-operation to assign one half of the double-wide data register value to a general register; and
otherwise, generating a micro-operation to assign one half of the double-wide data register value to a status collection register.

53. The method of claim 52, further comprising:
if the pre-determined number of prior fill operations has not been performed, generating a micro-operation to extract a status bit from a status collection register.

54. The method of claim 52, further comprising:
generating one or more additional micro-operations to perform a second fill operation;
wherein generating the one or more additional micro-operations includes:
generating a micro-operation to assign the other half of the double-wide data register data to a general register.

55. The method of claim 54, wherein generating one or more additional micro-operations further comprises:
generating the micro-operation to assign a general register to the other half of the double-wide data register value only if a predetermined number of prior fill operations has occurred;
otherwise, generating a micro-operation to assign the other half of the double-wide data register to a status collection register.

56. A method comprising:
generating micro-operations to perform, in a single cycle, M parallel memory operations in support of register windowing, where M>1;
wherein generating micro-operations further comprises:
utilizing a first memory pointer register to determine the memory address for a first memory operation; and
utilizing a second memory pointer register to determine the memory address for a second memory operation.

57. The method of claim 56, wherein generating micro-operations further comprises:
utilizing an Nth memory pointer register to determine the memory address for the Nth memory operation.

58. The method of claim 56, wherein:
the first and second memory pointer registers provide memory addresses for store operations.

59. The method of claim 56, wherein:
the first and second memory pointer registers provide memory addresses for load instructions.

60. The method of claim 58, further comprising:
incrementing the values of the first and second memory pointer registers by M*x, where x is the size of the data to be stored during each of the store operations.

61. The method of claim 59, further comprising:
decrementing the values of the first and second memory pointer registers by M*x, where x is the size of the data to be loaded during each of the load operations.
